(19) United States
(12) Patent Application Publication
(10) Pub. No.: US 2015/0268643 A1
(43) Pub. Date: Sep. 24, 2015

(54) Quantifying the Impact of Constraints on a Grid-Tied Microgrid Using Optimal Control

(71) Applicant: NEC Laboratories America, Inc., Princeton, NJ (US)

(72) Inventors: Rakesh Patil, San Francisco, CA (US); Ratnesh Sharma, Fremont, CA (US)

(73) Assignee: NEC Laboratories America, Inc., Princeton, NJ (US)

(21) Appl. No.: 14/150,708

(22) Filed: Jan. 8, 2014

(51) Int. Cl. G05B 13/02; G05F 1/66; H01L 31/04

(52) U.S. Cl. CPC G05B 13/024; H02S 10/00; G05F 1/66

(57) ABSTRACT

Systems and methods are disclosed to evaluate the impact of a constraint on the performance of the microgrid by receiving as input a set of solar power, load and grid cost conditions; applying dynamic programming to determine optimal battery dispatch and the imported grid power; and optimizing microgrid operation with a chosen constraint of interest.

This application is a utility conversion and claims priority to Provisional Application Ser. 61/733,561 filed Dec. 5, 2012, the content of which is incorporated by reference.

### BACKGROUND

The present invention relates to using optimal control to quantify the impacts of necessary constraints on the operating performance of microgrids.

Previous work in the consideration of constraints for microgrid operation has focused on two main aspects: First, definition of certain basic constraints which guarantee system stability and safe operation at both the device and system levels. These are crucial constraints defined with stability margins or component health in mind and in most cases the thresholds defining the constraints are chosen subjectively based on prior knowledge and experience. For example, battery charging at a constant current is considered to be less damaging to the battery than charging at variable currents, though the actual value of the constant current is subjectively chosen. The second area of research is on developing optimal control process (necessary for improving microgrid operation) with the focus on resolving the numerical challenges in incorporating constraints. Such studies demonstrate different approaches to include constraints in established optimization routines. However, they do not focus on evaluating the impact or sensitivity of necessary practical constraints.

### SUMMARY

In one aspect, a method to evaluate the impact of a constraint on the performance of the microgrid includes receiving as input a set of solar power (or other power sources), load and electric grid cost conditions; applying dynamic programming (or similar optimal control methods) to determine optimal battery dispatch and the imported grid power; and optimizing microgrid operation with a chosen constraint of interest.

Implementations of the above aspect may include one or more of the following. The method includes determining grid power (P_{g}) using the optimal battery dispatch power (P_{b}) through power balance:

P_{g}(k)+P_{b}(k)=Pₗ(k)−Pₚᵥ(k)

Where the power from the photovoltaic source is Pₚᵥ and the load power is Pₗ

Utilizing the optimal battery power dispatch (P_{b}), the battery state of charge (SOC) can be determined as:

$$SOC ( k + 1 ) = SOC ( k ) - \frac{I ( k ) Δ t}{Q}$$

$$I ( k ) = \frac{{P}_{b} ( k )}{{V}_{t}}$$

$${SOC}_{m i n} \leq SOC ( k ) \leq {SOC}_{ma x}$$

$${P}_{b , m i n} \leq {P}_{b} \leq {P}_{b , ma x}$$

where I(k) is current flowing through the battery and Q is an Amp-hour capacity of the battery with a constant terminal voltage (Vₜ) equal to a nominal battery voltage.

The process includes determining battery power dispatch (P_{b}) by minimizing an objective:

$${min}_{\{ {P}_{b} \}} J = {\sum }_{k = 0}^{T} {P}_{g} ( k ) {c}_{g} ( k ) Δ t .$$

The above optimization process is repeated to include constraints such as battery charging in a constant-current-constant-voltage (CCCV) manner (or a multitude of other device or infrastructure constraints). The results of microgrid operation are compared with and without the chosen constraint to determine the optimal operational impact (or cost) of the chosen constraint.

Advantages of the preferred embodiments may include one or more of the following. The system presents a unique method (based on optimization of the control actions) to quantify the impact of practical constraints on the performance of a grid-tied microgrid. In a microgrid (grid tied or islanded), the dispatch decisions for the generation and storage devices clearly affect the performance of the microgrid in terms of dollar cost, energy efficiency, emissions or other objectives of interest. Optimal control methods such as dynamic programming (which is globally optimal) are utilized to determine the dispatch decisions in order to maximize or minimize the desired objective. However, several practical considerations such as device level power and energy constraints, constraints on power flow etc., electric grid infrastructure constraints result in a loss of performance compared to the non-constrained optimal solution. The analysis presented in this work attempts to quantify the impact of such practical considerations on the optimal performance of a microgrid. An important advantage of our unique method is the use of optimal control to evaluate the impact of a constraint on the costs incurred in operating the microgrid. First, we optimize the microgrid operation with a model without any restrictive practical constraints (but with the basic constraints guaranteeing stable operation). This result is designated the benchmark or baseline. Then, we repeat the optimization of the microgrid operation with the constraint of interest. The optimal cost from this optimization to the baseline to quantify the impact of the constraint on the costs incurred in the operation of the microgrid. In particular the impact of battery charging at constant current-constant voltage (CC-CV) and the impact of reduced battery capacity have been evaluated in our work. The second major advantage of our approach is: Since the system cost (or performance), with and without the constraints are evaluated using the same optimization process we obtain a fair (apples-to-apples) comparison of the system performance with and without the constraint. Finally, our method can be used to analyze the impact of different constraints before implementing a particular control solution on the system. Moreover, by analyzing and understanding the sensitivity of different threshold values of a constraint on the optimal performance, improvements in system design towards reduced operational cost can be attained.

### BRIEF DESCRIPTION OF THE DRAWINGS

FIG. 1 shows an exemplary process 100 with optimal control using dynamic programming to optimize a power system with solar energy source operating with a microgrid.

FIG. 2 shows an exemplary process to evaluate the impact of a constraint on the performance of the microgrid.

FIG. 3 shows an exemplary power flow between the microgrid components.

FIG. 4 shows an exemplary computer to run the process of FIG. 1.

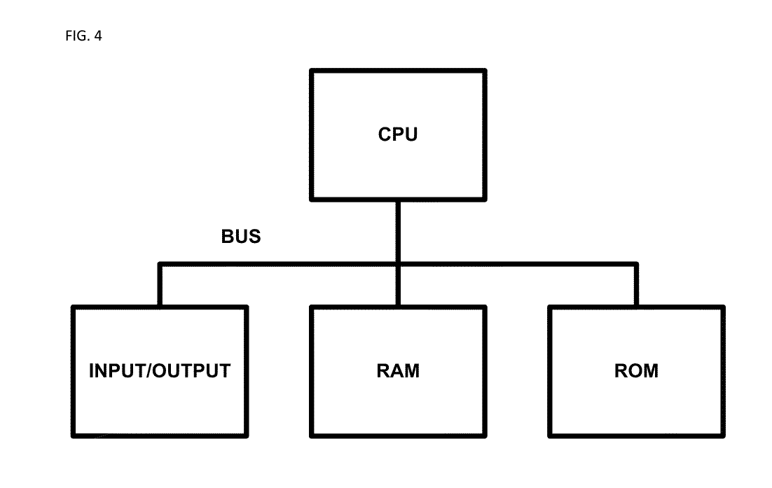

### DESCRIPTION

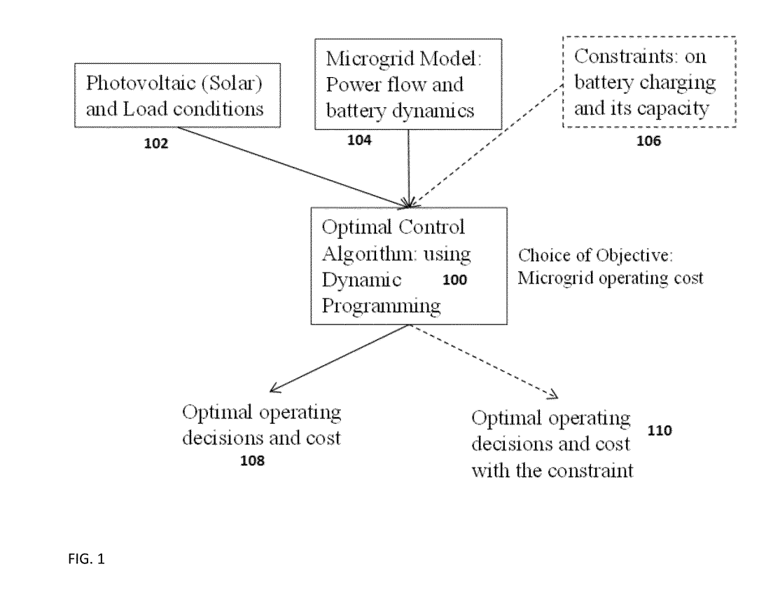

FIG. 1 shows an exemplary process 100 with optimal control using dynamic programming to optimize a power system with solar energy source operating with a microgrid. In the process of FIG. 1, the solar and load conditions 102 are the solar power and the power demanded by the load. A microgrid model 104 provides information on a microgrid power flow and battery dynamics. The power flow in the microgrid is optimized to obtain minimum operating costs 108-110. The objective of interest can also be to minimize emissions of different types. The optimization of this power flow is performed using dynamic programming. This optimization is repeated with an extra constraint of interest, such as a constraint on battery charging.

In FIG. 1, the use of an optimal control process (central block) to understand the impact of a constraint on the operation of the microgrid. The metric quantifying the impact of the chosen constraint is determined as the percentage increase in the optimal operating cost (or emissions) with the inclusion of the constraint. The optimal operating decisions under the extra constraint are also scrutinized to provide intuition on the impact of the constraint.

A dynamic programming based optimal control process is described which minimizes imported grid energy costs for a microgrid's operation. The imported grid energy cost is minimized for cases of sunny and cloudy days and these cases are used as a benchmark to quantify the impact of constraints. Then, the optimal cost performance of the microgrid is obtained for a CCCV battery charging constraint, and a reduced battery capacity constraint (other similar constraints of interest can be considered). It was observed that the optimal microgrid operation cost and the grid energy imported in the presence of these constraints was significantly higher than without the constraints. In this manner the impact of a constraint is determined.

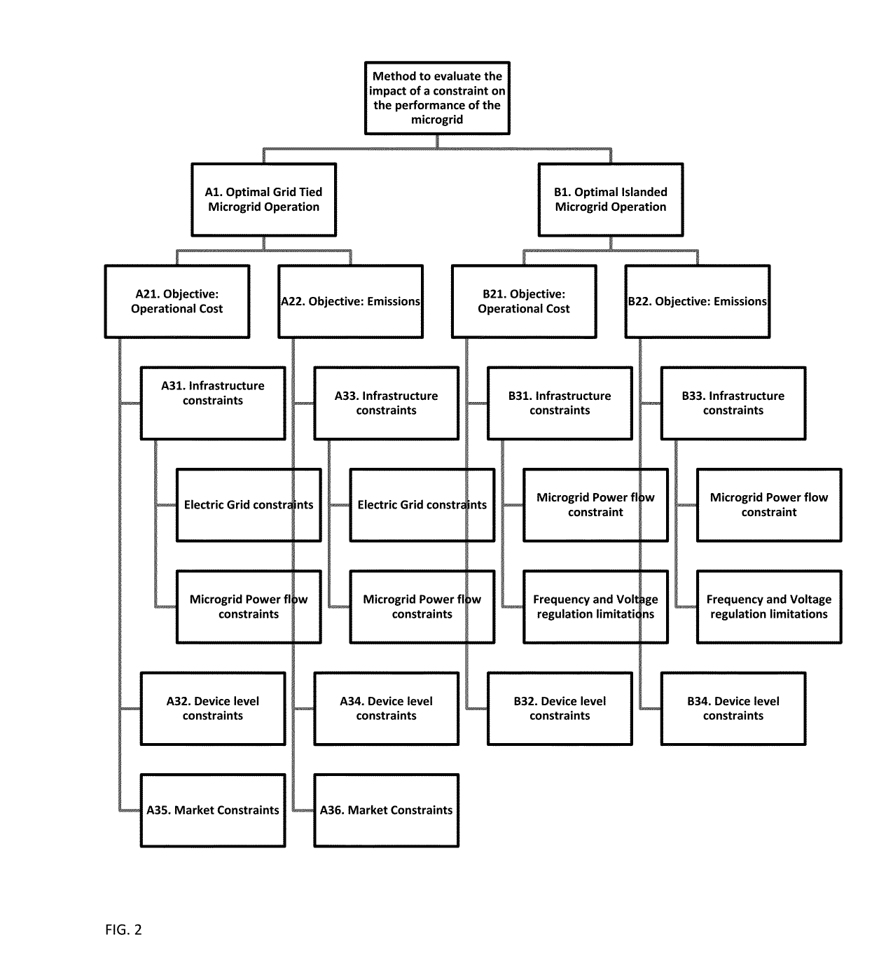

FIG. 2 shows an exemplary process to evaluate the impact of a constraint on the performance of the microgrid. The method can be applied to microgrid operation in a grid-tied fashion or islanded fashion. The performance of the microgrid can be defined in terms of operation costs (blocks A21 or B21) or emissions of different types (blocks A22 or B22). Our method is capable of evaluating the impact of a chosen constraint on the performance objective of interest. These constraints could be active at various levels. Blocks A31-A36 and B31-B34 describe different types of constraints that are of importance in a practical sense. The system of FIG. 2 can be used to understand the impact of market constraints (block A35), which is related to electricity pricing and hence impacts the operational cost objective (block A21) for grid-tied microgrid operation (block B1). Similarly, the system can be used to understand the impact of a device level constraint (block B34) such as battery charging limits on the emissions resulting (block B22) from islanded microgrid operation (block B1).

In one embodiment, the method to evaluate the impact of a constraint on the performance of the microgrid includes evaluations with:

A1. Optimal Grid Tied Microgrid Operation

A21. Objective: Operational Cost

A31. Infrastructure constraints
Electric Grid constraints
Microgrid Power flow constraints

A32. Device level constraints

A35. Market Constraints

A22. Objective: Emissions

A33. Infrastructure constraints
Electric Grid constraints
Microgrid Power flow constraints

A34. Device level constraints

A36. Market Constraints

B1. Optimal Islanded Microgrid Operation

B21. Objective: Operational Cost

B31. Infrastructure constraints

Microgrid Power flow constraint

Frequency and Voltage regulation limitations

B32. Device level constraints

B22. Objective: Emissions

B33. Infrastructure constraints

Microgrid Power flow constraint

Frequency and Voltage regulation limitations

B34. Device level constraints

In FIG. 2, constraints at different levels (blocks A31-A36 or B31-B34) impact the objective (as chosen in A21, A22, B21 or B22). In our approach, by relating the impact of every constraint to the objective we analyze the impact of constraints in an elegant manner through a single metric of interest. This approach is different from previous efforts that understand constraints at their level only (at the device etc.) and do not relate their impact explicitly to a system level objective.

Since the optimal performance of the microgrid is calculated with and without constraints using the central block in FIG. 1, the performance comparison (i.e. increase in the microgrid operation cost) is based on a comparison of two best-case scenarios. Furthermore, since the same process is used for optimization in the cases with and without the constraint, numerical issues such as discretization have an equal impact on each solution. Thus our approach obtains a fair comparison of two cases to calculate the cost impact of a constraint.

The system can also be used to design the microgrid system with a better cost or emissions performance. Currently most constraints are chosen on the more conservative side based on subjective considerations related to safety and stability. Our approach of understanding the cost impact of a constraint can be used to set favorable constraints with respect to microgrid operation costs or emissions.

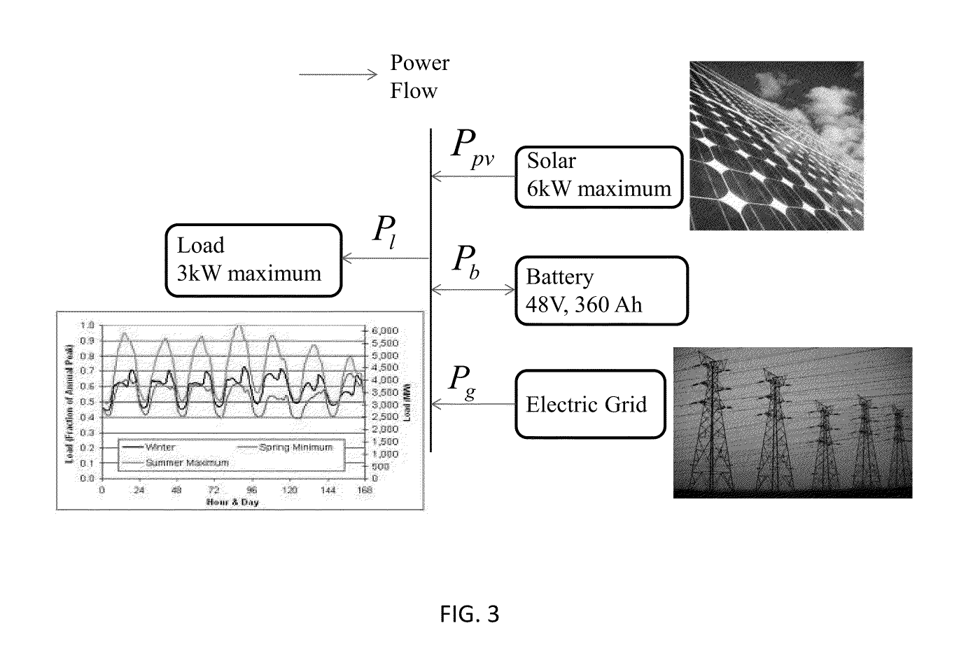

An exemplary power flow between the microgrid components is schematically shown in FIG. 3. The arrows indicate the possible directions of power flow and the component's power rating (our method can be utilized for any component rating and FIG. 3 is one embodiment). The power discharged/charged by the battery (P_{b}) and the power imported from the grid (P_{g}) are the variables of importance in our work. For this reason, and to considerably simplify the model we do not consider any power conversion devices—however our method is capable of incorporating such concerns.

The microgrid system is modeled with one state, i.e. the battery State Of Charge (SOC) and one input, i.e. the battery power input (P_{b}). The equations describing the power flow in FIG. 3 and the SOC dynamics are presented below.

Positive values of power imply that the power is flowing away from the microgrid element. In this work, power flow towards the grid is not allowed (only a simplification for this example); hence we obtain (1) for grid power (P_{g}).

P_{g}≧0 (1)

Equation (2.a) states that if the power from the PV (Pₚᵥ) is less than that of the load (Pₗ) then the battery (P_{b}) and the grid (P_{g}) have to provide for the additional load. Equation (2.b) states that when the power from the PV exceeds the load, then the battery is not constrained to always absorb the excess power. Such a formulation ensures that the battery is not overcharged and (2) has to be satisfied at each time instant k.

if (Pₗ(k)−Pₚᵥ(k))≧(k))0

P_{g}(k)+P_{b}(k)=Pₗ(k)−Pₚᵥ(k) (2.a-b)

if (Pₗ(k)−Pₚᵥ(k))<0

P_{g}(k)+P_{b}(k)≧Pₗ(k)−Pₚᵥ(k)

The SOC dynamics of the battery are described by (3.a), where I(k) is the current flowing through the battery and Q is the Amp-hour capacity of the battery. The current flowing through the battery is calculated using (3.b) using the battery power (P_{b}), and assuming a constant terminal voltage (V) equal to the nominal battery voltage (48V). The SOC is to be maintained between 0.3 and 0.9 at all times. These bounds are subjectively chosen and a case study with different bounds will be presented in the results section. The initial and final SOC of the battery are restricted to be equal (to 0.7) for the 24 hour horizon. This means that the battery is a net zero energy provider (i.e. not a generation source), because it is used only as storage.

$$SOC ( k + 1 ) = SOC ( k ) - \frac{I ( k ) Δ t}{Q} \\ I ( k ) = \frac{{P}_{b} ( k )}{{V}_{t}} \\ 0.3 \leq SOC ( k ) \leq 0.9 \\ - 6 kW \leq {P}_{b} \leq 6 kW \qquad ( 3. a \text{-} d )$$

The maximum battery charging and discharging current are constrained, which results in a constraint on battery power, as described in (3.d). An important aspect of practical interest is that it is favorable to charge the battery in a constant-current-constant-voltage (CCCV) manner. We will focus on understanding the impact of such a battery constraint but other constraints related to different devices or the power flow in the entire microgrid can be easily considered as well.

The optimal control problem is formulated as follows:

$${min}_{\{ {P}_{b} \}} J = {\sum }_{k = 0}^{T} {P}_{g} ( k ) {c}_{g} ( k ) Δ t \\ subject to Equation 1 - 3 \qquad ( 4 )$$

The objective of the optimization is to minimize the total cost of the grid energy imported by optimally controlling the input to the system, i.e. battery power dispatch (P_{b}) at every time step k. It should be noted that the value of P_{b} determines the SOC trajectory through (3) as well as the necessary amount of grid power to be imported using (2). The optimization is performed over a 24 hour horizon (i.e. T=24 hours) with 5 minute time steps (i.e. Δt=5 min). The cost of grid electricity at time step k is c_{g}(k).

The system compares the optimal control performance of different cases in order to understand the impact of different constraints on microgrid operation. The PV, load and grid cost conditions, which vary throughout the day (and year), significantly affect the optimal control decisions and hence the comparison of the optimal control performance of different cases.

Two different PV power profiles are considered representing a sunny day and a cloudy day. We obtain the results and present our discussion under these PV power assumptions and our approach can be easily adapted for different PV conditions. Similarly the load and grid costs are assumed to demonstrate the usefulness of our method but our approach is equally valid for different conditions assumed.

The difference between the load and the PV power is termed as the power demand (P_{dem}). The demand can be calculated using (5) for the sunny and cloudy day cases. Negative power demand indicates that the PV power exceeds the load presenting charging opportunities for the battery

P_{dem}(k)=Pₗ(k)−Pₚᵥ(k) (5)

The Dynamic Programming process described by the Bellman equation (Eq. 6) is used for optimal control in our work. Other optimal control algorithms can also be used depending on the microgrid model and the computational resources available. Dynamic Programming is chosen as it is a proven dynamic optimization method that guarantees global optimality.

$$V ( k , {x}^{i} ( k ) ) = {min}_{X ( k + 1 , {x}^{i} ( k ) )} \{ c ( {x}^{i} ( k ) , {x}^{j} ( k + 1 ) ) + V ( k + 1 , {x}^{j} ( k + 1 ) ) \} \qquad ( 6 )$$

In Eq. 6, c(xⁱ (k),x^{j}(k+1)) is the cost of transitioning from state xⁱ at time k to x^{j} at time k+1. This one-step or instantaneous cost in our problem is the cost of grid energy imported at time step k to accomplish the transition from state xⁱ at time k to x^{j} at time k+1. V(k,xⁱ(k)) is the optimal cost to go from state xⁱ at time k to the final time or the value function. Thus Eq. 6 states that the optimal cost to go from state xⁱ at time k to the final time is the minimum (over all states at time k+1) of the sum of the instantaneous cost (c) and the optimal cost to go from time step k+1.

The state space is divided into a finite number of states at every time step that belong to the set X(k)={x¹(k),x² (k), . . . xⁱ(k), . . . x^{j}(k), . . . x^{N}(k)}. In (6), the optimal cost to go from state xⁱ at time k is calculated as a minimization of costs associated with all reachable transitions to states in X(k+1) (i.e. X(k+1, xⁱ(k))). This equation is evaluated starting from final time T_{f}, where the optimal cost to go function at the final time V(T_{f},X(T_{f})) is initialized for all states. Then (6) is repeated for every state at every time step proceeding backward in time till the initial time. Through this process, we obtain V(1,X(1)), which gives the optimal cost to go from every state at the initial time and is used to find the optimal initial states and the consequent optimal trajectories.

The foregoing optimal control process based on dynamic programming has been applied to minimize imported grid power costs in a grid-tied microgrid. Furthermore, this process is used to understand the impact of different constraints on the system's optimal performance. Microgrids are considered an important element of the future smart grid and are valuable in islanded operation. This is due to their potential to increase energy security and reliability, integrate renewable power sources and enable efficient and smart grid operation. Optimal control of power flow in a microgrid along with an improved communication infrastructure can help accomplish the above tasks. In this paper, an optimal control process is developed and applied to a microgrid with the goal of minimizing imported grid energy costs and understanding the impact of constraints on the optimal cost.

The above DP based optimal control process can evaluate the optimal solutions with and without the constraint. Then, the impact of the constraint on the objective is quantified by comparing the optimal objective values. The DP approach uses Bellman's principle for optimal control, and thus guarantees dynamic optimality.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to evaluate the impact of a constraint on the performance of the microgrid, comprising:
receiving as input a set of solar power, load and grid cost conditions;
applying dynamic programming or similar optimal control method to determine optimal battery dispatch and the grid power requirements with and without a chosen constraint of interest; and
examining the optimal operation and associated costs with and without the constraint to evaluate the impact of the constraint of interest.

2. The method of claim 1, comprising determining grid power (P_{g}) and battery power (P_{b}) through power balance:
P_{g}(k)+P_{b}(k)=Pₗ(k)−Pₚᵥ(k)
where the power from a photovoltaic source is Pₚᵥ and the load power is Pₗ

3. The method of claim 2, comprising determining a battery state of charge (SOC) using battery power (P_{b}) as:
$$SOC ( k + 1 ) = SOC ( k ) - \frac{I ( k ) Δ t}{Q}$$
$$I ( k ) = \frac{{P}_{b} ( k )}{{V}_{t}}$$
$${SOC}_{m i n} \leq SOC ( k ) \leq {SOC}_{m ax}$$
$${P}_{b , m i n} \leq {P}_{b} \leq {P}_{b , ma x}$$
where I(k) is current flowing through the battery and Q is an Amp-hour capacity of the battery with a constant terminal voltage (Vₜ) equal to a nominal battery voltage.

4. The method of claim 1, comprising of determining the optimal battery dispatch (P_{b}) by solving:
$${min}_{\{ {P}_{b} \}} J = {\sum }_{k = 0}^{T} {P}_{g} ( k ) {c}_{g} ( k ) Δ t$$

5. The method of claim 1, comprising of solving for the optimal battery dispatch with battery constraints such as constant-current-constant-voltage (CCCV) charging and comparing the result to the result of claim 4.

6. The method of claim 1, comprising determining optimal Grid Tied Microgrid Operation.

7. The method of claim 4, comprising optimizing operational cost.

8. The method of claim 7, comprising optimizing with infrastructure constraints and comparing the optimal performance to the result of claim 7.

9. The method of claim 8, wherein the constraints include Electric Grid constraints and Microgrid Power flow constraints.

10. The method of claim 7, comprising optimizing with device level constraints and comparing the optimal performance to the result of claim 7.

11. The method of claim 7, comprising optimizing with market constraints and comparing the optimal performance to the result of claim 7.

12. The method of claim 4, comprising minimizing environmental emissions.

13. The method of claim 12, comprising optimizing with infrastructure constraints, device level constraints, or market constraints and comparing the result to the result of claim 12.

14. The method of claim 13, wherein the constraints include Electric Grid constraints and Microgrid Power flow constraints.

15. The method of claim 1, comprising determining optimal Islanded Microgrid Operation.

16. The method of claim 15, comprising optimizing operational cost or emissions.

17. The method of claim 16, comprising optimizing with infrastructure constraints and comparing the result to the result of claim 16.

18. The method of claim 17, wherein the constraints include Microgrid Power flow constraints or Frequency and Voltage regulation limitations.
